(19) United States
(12) Patent Application Publication
(10) Pub. No.: US 2025/0058160 A1
(43) Pub. Date: Feb. 20, 2025

(54) TRIGGERING DEVICE FOR A FIRE EXTINGUISHING SYSTEM

(71) Applicant: VTI VENTIL TECHNIK GMBH, Menden (DE)

(72) Inventors: Rafael RODRIGUEZ, Menden (DE); Markus PUETZ, Hagen (DE); Tobias MUELLER, Unna (DE); Marko CUTURA, Menden (DE)

(21) Appl. No.: 18/722,734

(22) PCT Filed: Oct. 31, 2022
(86) PCT No.: PCT/DE2022/100804

§ 371 Date: Jun. 21, 2024

(30) Foreign Application Priority Data
Dec. 23, 2021 (DE) 10 2021 134 603.7

(51) Int. Cl. A62C 35/68; A62C 37/44; A62C 37/46

(52) U.S. Cl. CPC A62C 35/68; A62C 37/44; A62C 37/46

(57) ABSTRACT

The present disclosure relates to a fire extinguishing arrangement having a gas cylinder with a fire extinguishing medium and a triggering device connected thereto, the triggering device is detachably coupled to a cylinder connection, and a piston is in the triggering device, the cylinder pressure of the medium located in the gas cylinder applied to the end faces opposite each other in the axial direction, the piston is arranged due to a spring force of a spring element in a blocked position and on the end face of the spring an outflow channel is fluidly connected to a sensor hose so when fire extinguishing medium flows out on the end face of the spring, the piston is displaced in the axial direction against the spring force, and a control channel is opened through the piston, so the fire extinguishing medium is able to be conducted through the control channel.

### RELATED APPLICATIONS

The present application is a National Phase of International Application Number PCT/DE2022/100804 filed Oct. 31, 2022, and claims priority of German Application Number 2021 134 603.7 filed Dec. 23, 2021.

### FIELD

The present disclosure relates to a fire extinguishing arrangement.

### BACKGROUND

Fire extinguishing systems installed in the interior of buildings. A fire extinguishing medium provided in a gas cylinder is connected to fire extinguishing lines.

In the event of a fire, the system is triggered automatically so that the fire extinguishing system is activated when a trigger element is activated.

For example, DE 10 2010 028 858 A1 or EP 3 744 405 A1 describe the system. Furthermore, DE 10 2010 028 857 A1 shows an automatic fire extinguishing system and EP 2 528 666 B1 a method for triggering pyrotechnical fire extinguishing devices. which is also described in US 2017/0 120 089 A1 and US 2016/0 279 453 A1.

### SUMMARY

The object of the present disclosure is to provide a triggering device of the fire extinguishing arrangement.

The aforementioned object is achieved according to the present disclosure with a fire extinguishing arrangement as described below.

The present disclosure also relates to a method for commissioning and/or maintaining the fire extinguishing arrangement described below.

The fire extinguishing arrangement according to the present disclosure has a gas cylinder with a fire extinguishing medium, for example N₂ (nitrogen). The gas cylinder is also referred to as a pressure vessel. A triggering device is connected thereto. The triggering device functions via a pressure switch.

According to at least one embodiment of the present disclosure, the triggering device is able to be detachably coupled to a cylinder connection of the gas cylinder. Triggering devices are part of the cylinder head. If maintenance work is therefore necessary or if the triggering device has been actuated, the entire gas cylinder would be replaced. In the solution according to the present disclosure, only the triggering device itself is able to be replaced or, in the case of a cylinder replacement, the triggering device is able to remain in place.

A piston is arranged in the triggering device itself, the cylinder pressure of the medium in the gas cylinder being applied to the end faces of the piston, which are opposite each other in the axial direction, wherein the piston is arranged in a blocked position due to the spring force of a spring element and/or a larger diameter of the end face of the piston. The blocking position is able to be in the idle state or monitoring state of the triggering device.

On the end face, on which the spring is also arranged, an outflow channel is fluidly connected to a sensor hose. When the fire extinguishing medium flows out from this end face of the spring, the piston moves in the axial direction against the spring force. This happens because the medium pressure is applied to the end face of the piston on the side of the gas cylinder. The medium pressure itself is greater than the spring force applied by the spring element. This opens a control channel so that the fire extinguishing medium is able to be conducted through the control channel to its intended purpose.

The actual cylinder valve is designed as a triggering valve. The control channel is able to therefore trigger the triggering valve and then release the contents of the cylinder in a pipe network with fire extinguishing nozzles.

To ensure that the pressure of the fire extinguishing medium is applied to both sides of the piston, in at least one embodiment a channel is formed on or in the piston, which connects both end faces to each other in a fluid-conducting manner. This ensures that the pressure of the fire extinguishing medium is applied to the piston on both ends after commissioning. Due to the spring force of the spring element, the piston is then moved into a closed position and held there.

In at least one embodiment, a throttle is arranged in the piston. The throttle throttles a medium flow due to the cylinder pressure of the fire extinguishing medium, towards the end face on which the spring element is located or downstream of which the sensor hose is located. This has the effect that when fire extinguishing medium flows out via the sensor hose, less fire extinguishing medium is able to flow through the channel of the piston due to the throttle, which is why there is less pressure on the face of the spring. The pressure of the fire extinguishing medium on end face opposite the end face of the spring, which is greater than the spring force of the spring element, thus pushes the piston against the spring force into an open position.

In at least one embodiment of the present disclosure, a pressure regulator or pressure reducer is provided on or in the sensor hose, for example, in the triggering device, which regulator or reducer regulates or converts the cylinder pressure to a lower relative sensor pressure.

In at least one embodiment of the present disclosure, a shut off valve is provided on the outflow side of the sensor hose on the triggering device. This means that the shut-off valve is able to initially be closed for commissioning. The same cylinder pressure is then applied to both end faces of the piston and the piston moves to its blocking position. If the shut-off valve is opened, a relatively lower flow pressure enters the sensor hose due to the pressure regulator described above.

The system is activated to the extent that the sensor hose melts at least locally due to a fire, causing the medium in the sensor hose to flow out. The piston is displaced by the outflowing medium.

### BRIEF DESCRIPTION OF THE DRAWINGS

Further advantages, features, properties and aspects of the present disclosure are illustrated in the following figures. In the figures, the same reference numerals are used for identical or similar components, although a repeated description is omitted for reasons of simplification. The figures being:

FIG. 1 shows a general view of the fire extinguishing arrangement

FIG. 2 shows a front view of the triggering device according to the invention

FIG. 3A and FIG. 3B show a sectional view along the sectional lines A-A and B-B of FIG. 2, FIG. 4A and FIG. 4B show the triggering device in the monitoring operating state with closed piston

FIG. 5A and FIG. 5B show the triggering device in the triggered operating state with open piston

FIG. 6 shows an illustration related to FIG. 3B of the triggering device with a sealing cap in the control channel.

### DETAILED DESCRIPTION

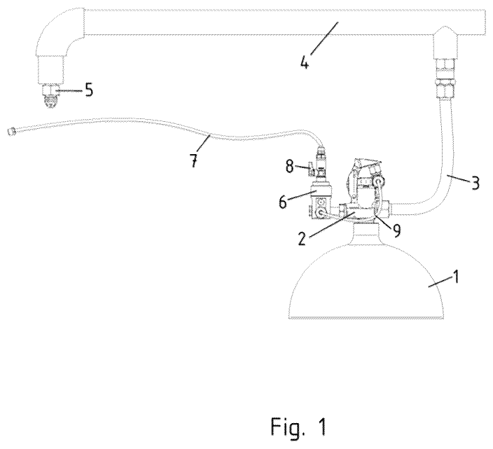

FIG. 1 shows a fire extinguishing arrangement according to at least one embodiment of the present disclosure. A gas cylinder 1 is filled with a fire extinguishing medium not shown in detail. The gas cylinder 1 has a cylinder head with a cylinder valve 2. The cylinder valve 2 is connected to a pipe network 4 via a connection line 3. Various fire extinguishing nozzles 5, for example in an interior of a building or also in an outdoor area, are fluidly connected to the pipe network 4.

According to at least one embodiment of the present disclosure, an external triggering device 6 is detachably connected to the cylinder valve 2. The triggering device 6 has a sensor hose 7. The sensor hose 7 is fluidly connected to the triggering device 6 via a shut-off valve 8. Furthermore, a control hose 9 is connected to the cylinder valve 2.

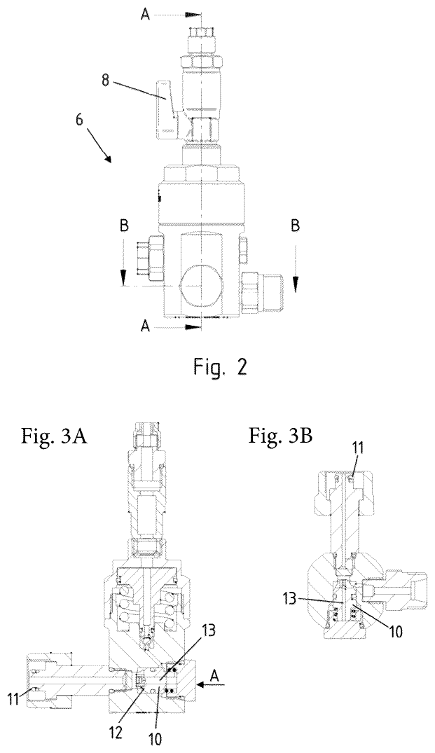

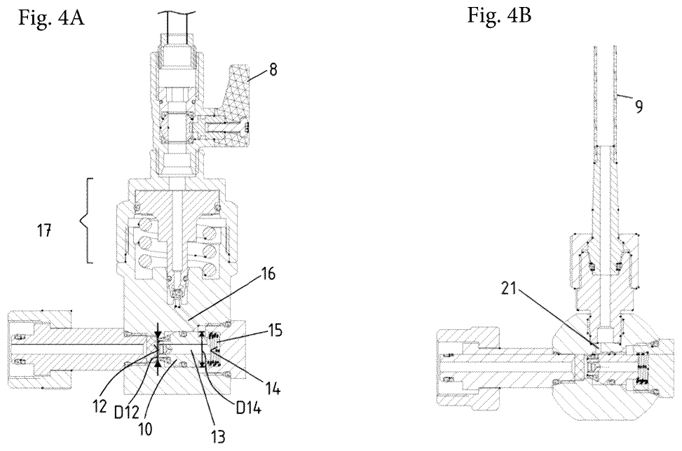

FIG. 2 shows a front view 12 of the triggering device 6 according to at least one embodiment of the present disclosure as well as the sectional lines A-A, B-B shown below in FIG. 3A and FIG. 3B as respective cross-sectional views.

A piston 10 movable in axial direction A is arranged in the triggering device 6. The triggering device 6 is detachably coupled to the cylinder valve 2 with a pressure connection 11 against a non-return valve not shown in detail, by means of a screw connection shown here. This means that the pressure of the fire extinguishing medium in the gas cylinder 1, also referred to as cylinder pressure, is in contact with a first end face 12 of the piston 10. In the piston 10 there is a channel 13 so that the cylinder pressure reaches a second end face 14 of the piston 10. At this second end face 14 a spring element 15, in this case a spiral compression spring, is also arranged. The cylinder pressure is therefore applied to both end faces 12, 14. In addition, shown on the right in relation to the image plane according to FIG. 4A, the piston 10 is pressed to the left in relation to the image plane due to the spring force. Alternatively or additionally, the diameter D14 of the end face 14 is larger than the diameter D12 of the end face 12. Due to the same pressure, but due to the larger diameter with a larger surface area on which the pressure is present or is exerted, the piston 10 is pushed to the left in relation to the image plane. The spring element 15 is able be used as an auxiliary element or safety element so that, if the different diameters and the spring element 15 are provided, the piston is always arranged in the locked position. An outflow channel 16 is fluidly connected, due to 10 this position, with the space in which the spring 15 is located, in which the medium pressure also prevails. A pressure reducer 17 converts this medium pressure into a lower sensor pressure, which in turn is fluidly connected to the sensor hose 7 due to the open position of the shut-off valve 8. The sensor pressure in the sensor hose is therefore lower than the cylinder pressure.

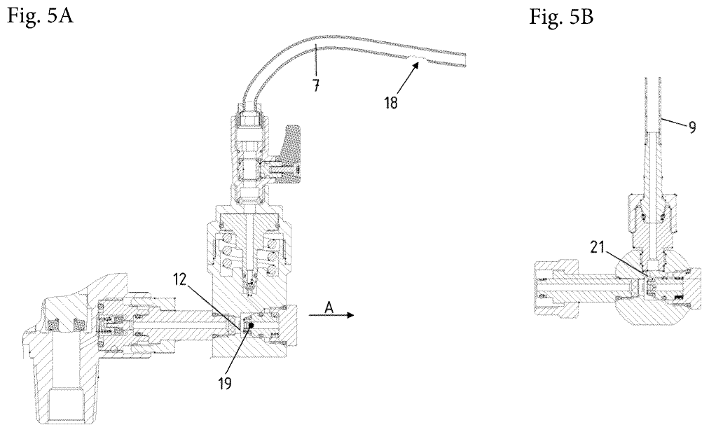

If now the situation shown in FIG. 5A and FIG. 5B occurs, in which the sensor hose 7 has at least a local leakage 18 or is damaged (due to a fire), medium flows out of the sensor hose 7. A throttle 19 located on the piston 10 ensures that less fire extinguishing medium is able to flow to the side of the spring than the quantity that flows out due to the leakage 18. The piston 10 is thus moved to the right in axial direction A on the image plane due to the cylinder pressure applied to the first end face 12, which is greater than the spring force. According to FIG. 5B, a control channel 21 is thus opened, which is fluidly connected to a control hose 9, which then actuates the cylinder valve 2 of the gas cylinder 1. The fire extinguishing medium is then released into the pipe network 4 via the connection line 3.

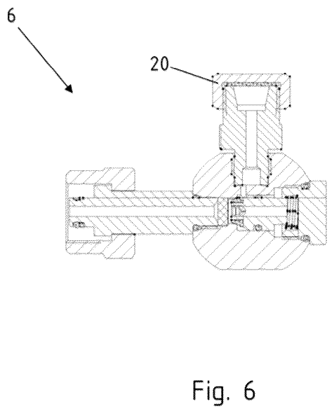

FIG. 6 shows a delivery state of the triggering device 6. A sealing cap 20 is connected on the side of the control hose 9. For commissioning, the triggering device 6 is able to be connected first, then the sensor hose 7 is able to be connected to the triggering device 6, the shut-off valve 8 is able to be opened so that the piston 10 reaches the position of FIG. 4A or FIG. 4B. The connection cap 20 as shown in FIG. 6 is able to then be unscrewed and the control line attached to the triggering device 6.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-8. (canceled)

9. A fire extinguishing arrangement comprising:
a gas cylinder comprising a fire extinguishing medium and a cylinder valve; and
a triggering device connected to the gas cylinder, the triggering device is detachably coupled to the cylinder valve, wherein a piston is in the triggering device, a cylinder pressure of the fire extinguishing medium located in the gas cylinder being applied to end faces of the piston opposite each other in an axial direction of the gas cylinder, and the piston is in a blocked position due to a spring force of a spring element and in a region of the end faces of the spring an outflow channel is fluidly connected to a sensor hose, such that in response to the fire extinguishing medium flowing out on the end faces of the spring, the piston is displaced in the axial direction against the spring force and a control channel is opened through the piston, so the fire extinguishing medium flows through the control channel.

10. The fire extinguishing arrangement according to claim 9, wherein a channel is in a head of the gas cylinder, and the channel connects both end faces in a fluid-conducting manner.

11. The fire extinguishing arrangement according to claim 9, wherein a throttle is in the piston, and the throttle is configured to throttle a medium flow originating from the cylinder pressure to the end face, on which the spring element is arranged.

12. The fire extinguishing arrangement according to claim 9, wherein a pressure reducer is connected upstream of the sensor hose, and the pressure reducer is configured to regulate the cylinder pressure to a lower sensor pressure relative thereto.

13. The fire extinguishing arrangement according to claim 9, wherein a shut-off valve is on one outflow side of the sensor hose on the triggering device.

14. The fire extinguishing arrangement according to claim 9, wherein the triggering device is mounted opposite a non-return valve of the gas cylinder and detachably coupled to the gas cylinder.

15. The fire extinguishing arrangement according to claim 9, wherein the control channel is fluidly connected to the cylinder valve of the gas cylinder in such a way that in response to the control channel being subjected to the medium pressure, the cylinder valve of the gas cylinder is triggered.

16. The fire extinguishing arrangement according to claim 9, wherein the piston comprises a smaller diameter at the end face than an opposite larger diameter of the end face, and the end face with the larger diameter is arranged on the side of the spring element.
